(19) United States
(12) Patent Application Publication
(10) Pub. No.: US 2018/0056208 A1
(43) Pub. Date: Mar. 1, 2018

(54) ASSEMBLY TOY

(71) Applicant: BENKAN CORPORATION, Gunma (JP)

(72) Inventors: Masanori NAKASHIMA, Hyogo (JP); Yoshiyuki MIYAKE, Osaka (JP)

(73) Assignee: BENKAN CORPORATION, Gunma (JP)

(21) Appl. No.: 15/560,298

(22) PCT Filed: Mar. 3, 2016
(86) PCT No.: PCT/JP2016/056555

§ 371 Date: Sep. 21, 2017

(30) Foreign Application Priority Data
Mar. 25, 2015 (JP) 2015-062551

(51) Int. Cl. A63H 33/08; A63H 3/16; B43K 21/00

(52) U.S. Cl. CPC A63H 33/084; B43K 21/006; A63H 3/16; A63H 33/088

(57) ABSTRACT

In the present invention, a toy block for an assembly toy has a first flat surface and a second flat surface at both ends. Formed on the first flat surface are male parts that project vertically and female parts that are vertically indented. Formed on the second flat surface are a male part that vertically projects, and female parts that are vertically indented. When two toy blocks are linked together, the male parts of one block fit into the female parts of other toy block, and the male part of the other toy block fits into a female part of the other toy block. This allows the linking surfaces of the toy blocks having the male parts and female parts to link to each other at a variety of angles. The toy blocks rotate relative to each other when linked together.

### TECHNICAL FIELD

The invention relates to an assembly toy.

### BACKGROUND ART

Conventionally, there are assembly toys that are played with by linking a plurality of blocks together to form various shapes. For example, PTL 1 describes a block assembly toy with which various shapes are three-dimensionally formed by alternately engaging depressed parts and projecting parts of a plurality of substantially cubic blocks each having projections and depressions on their six surfaces. Herein, the projecting parts and the depressed parts formed on each of the six surfaces of the block are constituted as a male part and a female part for linking the blocks together.

### CITATION LIST

### Patent Literature

[PTL 1] Japanese Patent No. 3567267

### SUMMARY OF INVENTION

### Technical Problem

However, in the block assembly toy in PTL 1, when the blocks are linked together, the surface of one block can be combined with the projection and the depression formed on the surface of another block only at a predetermined angle. That is, it is not possible to link the blocks together at a variety of angles. Accordingly, flexibility in forming by combining the blocks is limited.

The invention has been made in order to solve such a problem, and an object thereof is to provide an assembly toy capable of linking the linking surfaces of a plurality of toy blocks each having a male part and a female part on at least one surface together at a variety of angles.

### Solution to Problem

In order to solve the above problem, the assembly toy according to the invention is an assembly toy having a first toy block and a second toy block linkable to each other, wherein each of the toy blocks includes: at least one flat surface; a male part that projects and extends vertically from the flat surface; and a female part that is formed so as to be vertically indented from the flat surface in a direction opposite to the projection direction of the male part, the male part and the female part are provided on the same circumference on the flat surface, and the male part of the first toy block detachably fits into the female part of the second toy block and the male part of the second toy block detachably fits into the female part of the first toy block to allow the first toy block and the second toy block to link to each other and allow the first toy block to change a linking position relative to the second toy block.

In addition, in the assembly toy according to the invention, the first toy block may be movable relative to the second toy block while the state in which the first toy block and the second toy block are linked together is maintained.

Further, the male part of the toy block for the assembly toy according to the invention may have a columnar projecting part that projects from the flat surface, the female part may have a depressed part that is formed into an arc-shaped strip-like shape on the flat surface, the projecting part of the male part may be fittable into the depressed part of the female part in a width direction of the depressed part, and the projecting parts of the male parts of the first toy block and the second toy block may move along the depressed parts of the female parts of the first toy block and the second toy block while the state in which the first toy block and the second toy block are linked together is maintained to allow the first toy block to rotate relative to the second toy block.

In addition, the male part and the female part may be alternately disposed on the same circumference.

Further, the male part and the female part may be disposed on the same circumference by repeating an arrangement of at least one of the male parts and a plurality of the female parts larger in number than the male part.

### Advantageous Effects of Invention

According to the assembly toy according to the invention, it is possible to link the linking surfaces of a plurality of the toy blocks each having the male part and the female part on at least one surface together at a variety of angles.

### BRIEF DESCRIPTION OF DRAWINGS

FIG. 1 is a perspective view showing a small pipe-type block as an example of a toy block for an assembly toy according to an embodiment of the invention, and is a view showing a state in which two small pipe-type blocks are coupled to each other.

FIG. 2 is a plan view showing a detailed shape of a first flat surface of the small pipe-type block shown in FIG. 1.

FIG. 3A is a front view of the small pipe-type block shown in FIG. 1.

FIG. 3B is a rear view of the small pipe-type block shown in FIG. 1.

FIG. 3C is a left side view of the small pipe-type block shown in FIG. 1.

FIG. 3D is a right side view of the small pipe-type block shown in FIG. 1.

FIG. 3E is a plan view of the small pipe-type block shown in FIG. 1.

FIG. 3F is a bottom view of the small pipe-type block shown in FIG. 1.

FIG. 3G is a cross-sectional view of the small pipe-type block shown in FIG. 1 taken along the line A-A shown in FIG. 3E.

FIG. 3H is a cross-sectional view of the small pipe-type block shown in FIG. 1 taken along the line B-B shown in FIG. 3E.

FIG. 3I is a reference perspective view of the small pipe-type block shown in FIG. 1.

FIG. 4 is a perspective view showing a medium pipe-type block as an example of the toy block for the assembly toy according to the embodiment of the invention, and is a view showing a state in which two medium pipe-type blocks are coupled to each other.

FIG. 5A is a front view of the medium pipe-type block shown in FIG. 4.

FIG. 5B is a rear view of the medium pipe-type block shown in FIG. 4.

FIG. 5C is a left side view of the medium pipe-type block shown in FIG. 4.

FIG. 5D is a right side view of the medium pipe-type block shown in FIG. 4.

FIG. 5E is a plan view of the medium pipe-type block shown in FIG. 4.

FIG. 5F is a bottom view of the medium pipe-type block shown in FIG. 4.

FIG. 5G is a cross-sectional view of the medium pipe-type block shown in FIG. 4 taken along the line A-A shown in FIG. 5E.

FIG. 5H is a cross-sectional view of the medium pipe-type block shown in FIG. 4 taken along the line B-B shown in FIG. 5E.

FIG. 5I is a reference perspective view of the medium pipe-type block shown in FIG. 4.

FIG. 6 is a perspective view showing a large pipe-type block as an example of the toy block for the assembly toy according to the embodiment of the invention, and is a view showing a state in which two large pipe-type blocks are coupled to each other.

FIG. 7A is a front view of the large pipe-type block shown in FIG. 6.

FIG. 7B is a rear view of the large pipe-type block shown in FIG. 6.

FIG. 7C is a left side view of the large pipe-type block shown in FIG. 6.

FIG. 7D is a right side view of the large pipe-type block shown in FIG. 6.

FIG. 7E is a plan view of the large pipe-type block shown in FIG. 6.

FIG. 7F is a bottom view of the large pipe-type block shown in FIG. 6.

FIG. 7G is a cross-sectional view of the large pipe-type block shown in FIG. 6 taken along the line A-A shown in FIG. 7E.

FIG. 7H is a cross-sectional view of the large pipe-type block shown in FIG. 6 taken along the line B-B shown in FIG. 7E.

FIG. 7I is a cross-sectional view of the large pipe-type block shown in FIG. 6 taken along the line C-C shown in FIG. 7E.

FIG. 7J is a reference perspective view of the large pipe-type block shown in FIG. 6.

FIG. 8 is a view showing a state in which three small pipe-type blocks shown in FIG. 1 are coupled together with their center positions displaced from each other.

FIG. 9 is a view showing a state in which the small pipe-type block shown in FIG. 1 is coupled to the large pipe-type block shown in FIG. 6.

FIG. 10A is a perspective view showing a medium reducer-type block as an example of the toy block for the assembly toy according to the embodiment of the invention.

FIG. 10B is a plan view of the medium reducer-type block shown in FIG. 10A.

FIG. 10C is a bottom view of the medium reducer-type block shown in FIG. 10A.

FIG. 11A is a perspective view showing a medium cap-type block as an example of the toy block for the assembly toy according to the embodiment of the invention.

FIG. 11B is a plan view of the medium cap-type block shown in FIG. 11A.

FIG. 11C is a bottom view of the medium cap-type block shown in FIG. 11A.

FIG. 12A is a perspective view showing a small elbow-type (90 degrees) block as an example of the toy block for the assembly toy according to the embodiment of the invention.

FIG. 12B is a perspective view showing a small elbow-type (45 degrees) block as an example of the toy block for the assembly toy according to the embodiment of the invention.

FIG. 13A is a perspective view showing a small tee-type block as an example of the toy block for the assembly toy according to the embodiment of the invention.

FIG. 13B is a perspective view showing a small cross-type (180 degrees) block as an example of the toy block for the assembly toy according to the embodiment of the invention.

FIG. 13C is a perspective view showing a medium cross-type (90 degrees) block as an example of the toy block for the assembly toy according to the embodiment of the invention.

FIG. 14A is a side view showing a large cap-type (subtype) block as an example of the toy block for the assembly toy according to the embodiment of the invention.

FIG. 14B is a bottom view of the large cap-type (subtype) block shown in FIG. 14A.

FIG. 15A is a perspective view showing an example of a combination when various types of the toy blocks according to the embodiment of the invention are coupled together.

FIG. 15B is a perspective view showing an example of the combination when various types of the toy blocks according to the embodiment of the invention are coupled together.

FIG. 15C is a perspective view showing an example of the combination when various types of the toy blocks according to the embodiment of the invention are coupled together.

FIG. 16A is a perspective view showing an example in which a bear-like doll is assembled by using various types of the toy blocks according to the embodiment of the invention.

FIG. 16B is a front view of the bear-like doll shown in FIG. 16A.

FIG. 16C is a perspective view showing a state in which orientations of the face and feet of the bear-like doll shown in FIG. 16A are changed.

FIG. 17A is a perspective view of a portion of the face of the bear-like doll shown in FIG. 16A.

FIG. 17B is a side view of the portion of the face of the bear-like doll shown in FIG. 16A.

FIG. 17C is an exploded view of the portion of the face of the bear-like doll shown in FIG. 16A.

FIG. 18A is a view showing an example in which the toy block for the assembly toy according to the embodiment of the invention is applied for use as general merchandise.

FIG. 18B is a view showing an example in which the toy block for the assembly toy according to the embodiment of the invention is applied for use as general merchandise.

FIG. 19 is a perspective view showing an example of the mode of assembly of the toy block for the assembly toy according to the embodiment of the invention by showing displacement.

FIG. 20A is a perspective view showing an example of the mode of assembly of the toy block for the assembly toy according to the embodiment of the invention by showing displacement.

FIG. 20B is a side view showing another block to which the toy block according to the embodiment of the invention is coupled in the mode of the assembly shown in FIG. 20A.

FIG. 21 is a perspective view showing the toy block for the assembly toy shown as another example of the invention, and is a view showing a state in which two toy blocks are coupled to each other.

FIG. 22 is a perspective view showing the toy block for the assembly toy shown as another example of the invention, and is a view showing a state in which two toy blocks are coupled to each other.

FIG. 23A is a plan view showing the toy block for the assembly toy shown as another example of the invention.

FIG. 23B is a perspective view showing a state in which the toy blocks shown in FIG. 23A are coupled to each other.

### DESCRIPTION OF EMBODIMENTS

Hereinbelow, an embodiment of the invention will be described based on the accompanying drawings. Note that an assembly toy in the invention is a toy for forming structures having various shapes by detachably combining the various toy blocks described below.

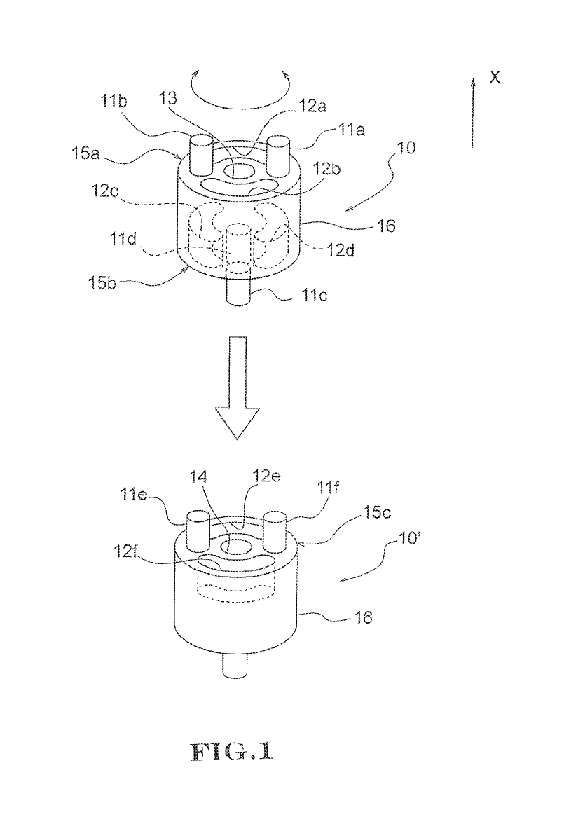

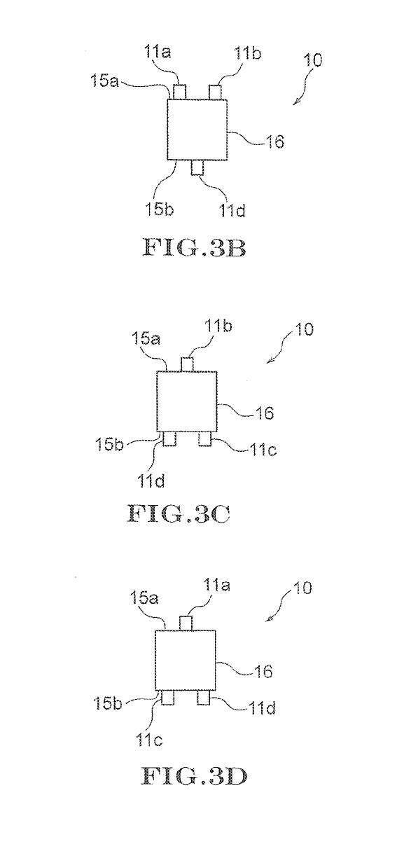

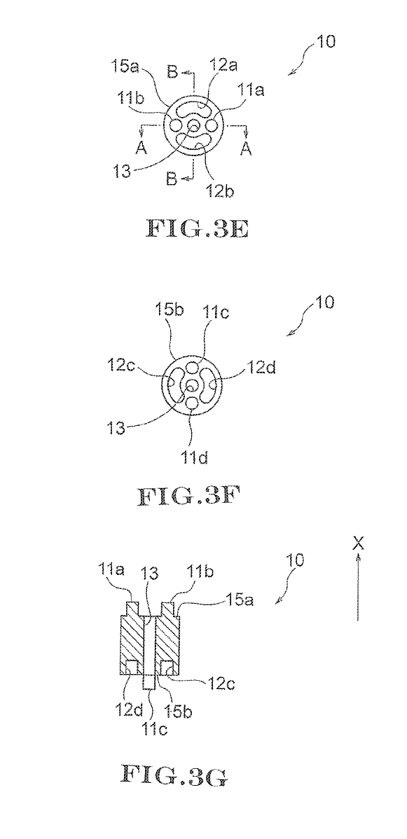

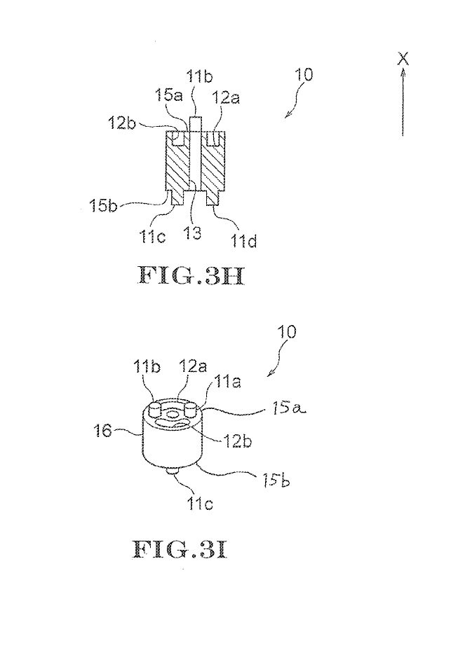

First, based on FIGS. 1 and 2 and FIGS. 3A to 3I, a description will be given of a small pipe-type block 10 as the toy block for the assembly toy. Note that a front view in FIG. 3A and a rear view in FIG. 3B are symmetrical, and a left side view in FIG. 3C and a right side view in FIG. 3D are symmetrical.

Referring to FIG. 1, the small pipe-type block 10 as a first toy block has a cylindrical portion 16 having a substantially cylindrical shape. At both ends of the cylindrical portion 16, a circular first flat surface 15a and a circular second flat surface 15b are formed in parallel with each other. Herein, a through hole 13 is formed in the central portion of the first flat surface 15a, and extends in an axial direction of the small pipe-type block 10. On the first flat surface 15a, male parts 11a and 11b as a pair of columnar projecting parts at positions symmetrical with respect to the through hole 13 project and extend vertically from the first flat surface 15a.

Note that, in the following description, it is assumed that the projection direction in which the male part projects vertically relative to the first flat surface is an X direction positive side, and the direction opposite to the X direction positive side is an X direction negative side.

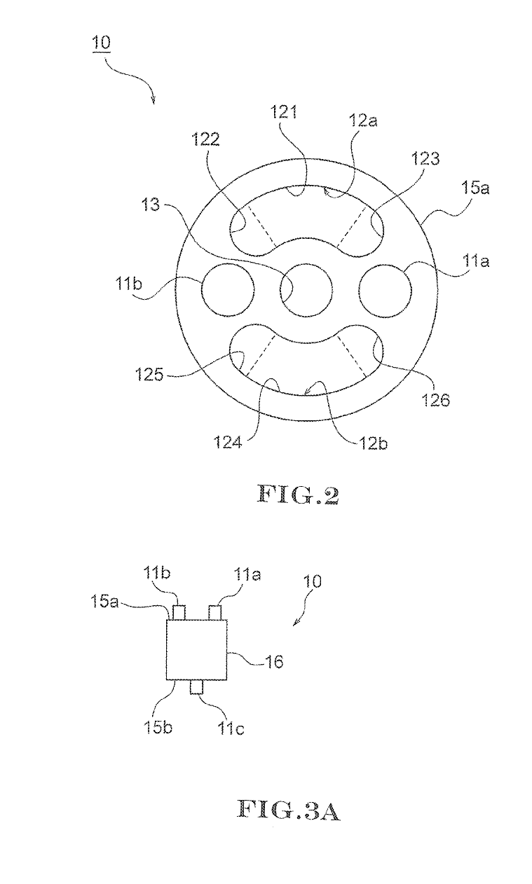

Between the male parts 11a and 11b, a pair of female parts 12a and 12b are formed at positions symmetrical with respect to the through hole 13. As shown in FIG. 2, the female part 12a is a depressed part having a shape in which semicircular parts 122 and 123 each having a substantially semicircular shape are connected to both ends of a strip-like part 121 having an arc-shaped slender strip-like shape, and is formed so as to be vertically indented from the first flat surface 15a in the X direction negative side. Similarly, the female part 12b is a depressed part having a shape in which semicircular parts 125 and 126 are connected to both ends of a strip-like part 124 having an arc-shaped slender strip-like shape, and is formed so as to be indented in the X direction negative side. That is, a pair of the female parts 12a and 12b are formed as arc-shaped strip-like grooves on the first flat surface 15a. Note that the length of each of the female parts 12a and 12b in a width direction is substantially identical to the diameter of each of the male parts 11a and 11b. In addition, the male parts 11a and 11b and the female parts 12a and 12b are provided so as to be disposed on the same circumference.

The second flat surface 15b has the same shape as that of the first flat surface 15a. That is, on the second flat surface 15b as well, a pair of male parts 11c and 11d and a pair of female parts 12c and 12d having the same shapes as those of the male parts 11a and 11b and the female parts 12a and 12b on the first flat surface 15a are formed. Herein, the female parts 12c and 12d are formed so as to be vertically indented from the second flat surface 15b in the X direction positive side that is opposite in direction to the X direction negative side as the projection direction of the male parts 11c and 11d. In addition, the male parts 11c and 11d and the female parts 12c and 12d are provided so as to be disposed on the same circumference. Note that, as shown in FIGS. 3E and 3F, the positions of the male parts 11a and 11b and the female parts 12a and 12b on the first flat surface 15a are different in phase from the positions of the male parts 11c and 11d and the female parts 12c and 12d on the second flat surface 15b by 90°.

Next, a description will be given of a coupling method when, as shown in FIG. 1, the small pipe-type block 10 is coupled to another small pipe-type block 10′ as a second toy block having the same structure.

Note that another small pipe-type block 10′ to be coupled to the small pipe-type block 10 includes, similarly to the small pipe-type block 10, a flat surface 15c on which male parts 11e and 11f and female parts 12e and 12f are formed. Consequently, when the small pipe-type block 10 is coupled to another small pipe-type block 10′, the male parts 11c and 11d on the second flat surface 15b of the small pipe-type block 10 are engaged with the female parts 12e and 12f on the flat surface 15c of another small pipe-type block 10′. Herein, the length in the width direction of each of the female parts 12e and 12f on the flat surface 15c of another small pipe-type block 10′ is substantially identical to the diameter of each of the male parts 11c and 11d on the second flat surface 15b of the small pipe-type block 10. Accordingly, the male parts 11c and 11d of the small pipe-type block 10 are fitted into and attached to the female parts 12e and 12f of another small pipe-type block 10′ so as not to be easily detached from the female parts 12e and 12f unless a pulling force is intentionally applied thereto. On the other hand, the male parts 11c and 11d of the small pipe-type block 10 can move in an arc-shaped pattern circumferentially along the female parts 12e and 12f in a state in which the male parts 11c and 11d are fitted into the female parts 12e and 12f of another small pipe-type block 10′.

In addition, the male parts 11e and 11f on the flat surface 15c of another small pipe-type block 10′ are engaged with the female parts 12c and 12d on the second flat surface 15b of the small pipe-type block 10 by the same method as that for the engagement between the male parts 11c and 11d and the female parts 12e and 12f. Herein, the length in the width direction of each of the female parts 12c and 12d on the second flat surface 15b of the small pipe-type block 10 is also substantially identical to the diameter of each of the male parts 11e and 11f on the flat surface 15c of another small pipe-type block 10′. Consequently, the male parts 11e and 11f of another small pipe-type block 10′ can move in the arc-shaped pattern circumferentially along the female parts 12c and 12d in a state in which the male parts 11e and 11f are fitted into the female parts 12c and 12d of the small pipe-type block 10. Therefore, after the small pipe-type block 10 and another small pipe-type block 10′ are coupled to each other, it is possible to rotate the small pipe-type block 10 and another small pipe-type block 10′ relative to each other as indicated by an arrow in FIG. 1 while maintaining the linked state. That is, the small pipe-type block 10 is capable of appropriately changing the linking position relative to the flat surface 15c of another small pipe-type block 10′.

Note that, in the case where the small pipe-type block 10 and another small pipe-type block 10′ that are coupled to each other are pulled with a specific force, it is possible to detach the small pipe-type block 10 and another small pipe-type block 10′ from each other. That is, the small pipe-type block 10 and another small pipe-type block 10′ are detachably coupled to each other.

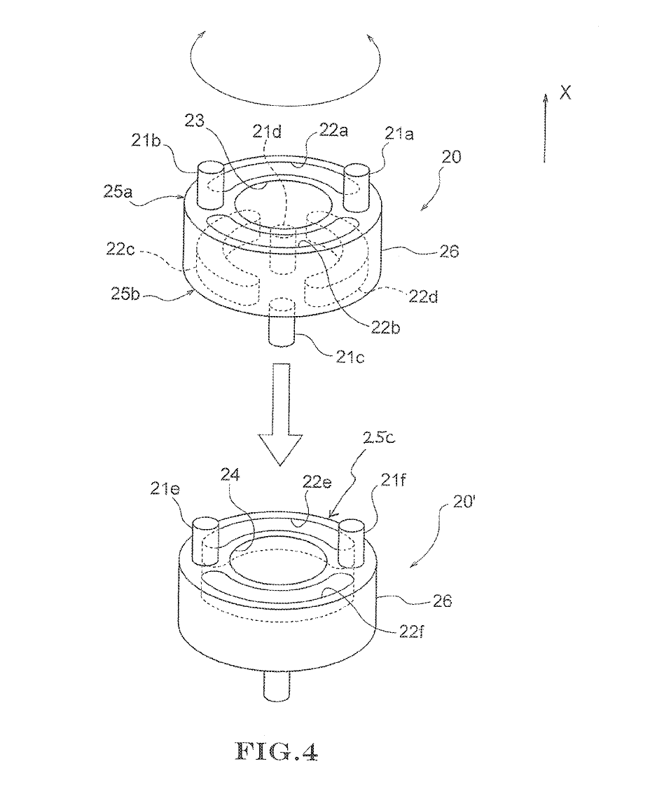

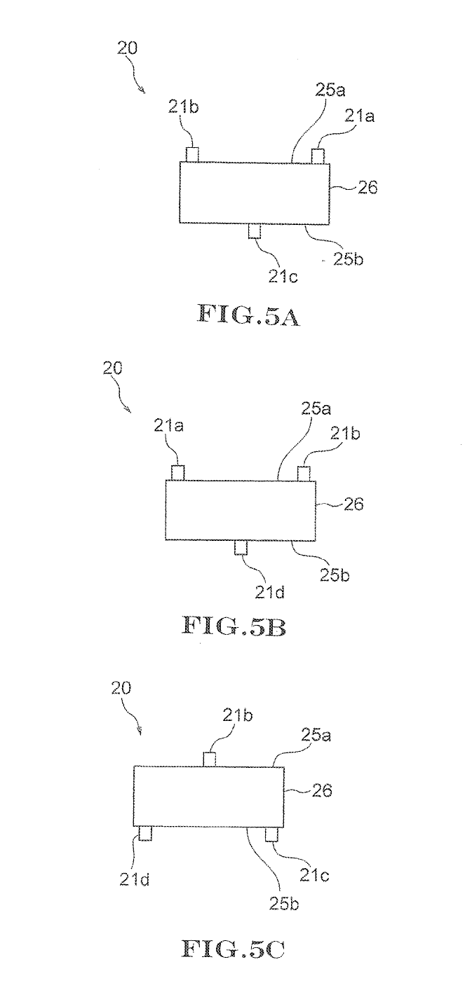

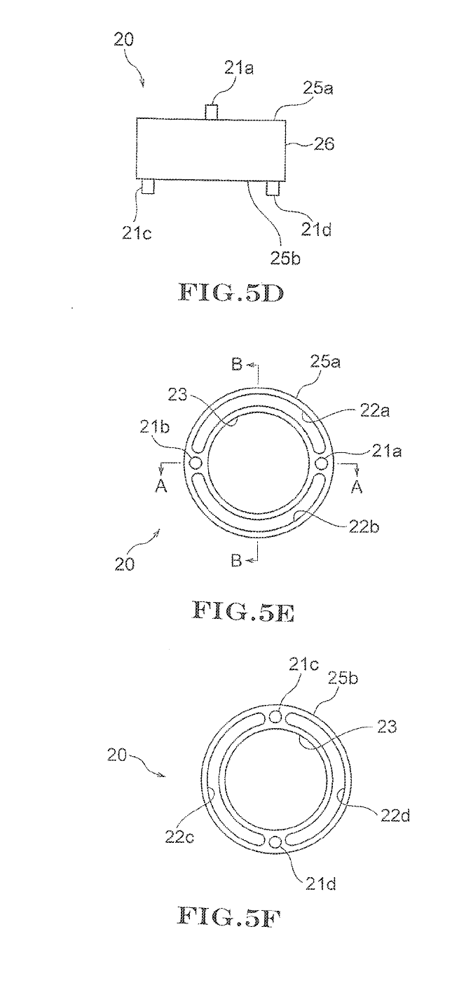

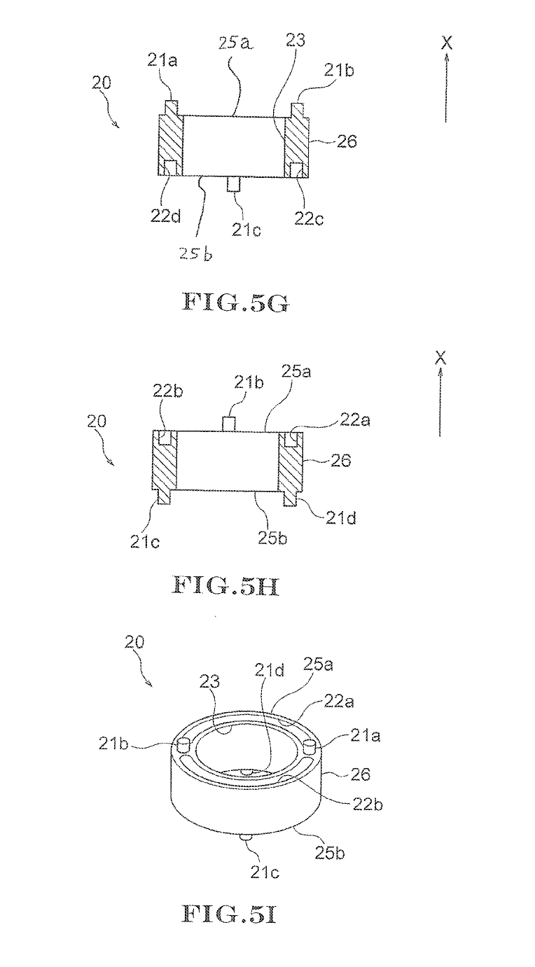

Next, based on FIG. 4 and FIGS. 5A to 5I, a description will be given of a medium pipe-type block 20 as the toy block for the assembly toy. Note that a front view in FIG. 5A and a rearview in FIG. 5B are symmetrical, and a left side view in FIG. 5C and a right side view in FIG. 5D are symmetrical.

The medium pipe-type block 20 as the first toy block has a cylindrical portion 26 having a substantially cylindrical shape. At both ends of the cylindrical portion 26, a first flat surface 25a and a second flat surface 25b as substantially annular flat surfaces are formed in parallel with each other. That is, the periphery of each of the first flat surface 25a and the second flat surface 25b is circular. Note that the size of the outer diameter of the first flat surface 25a or the second flat surface 25b of the medium pipe-type block 20 is larger than the size of the outer diameter of the first flat surface 15a or the second flat surface 15b of the small pipe-type block 10. Herein, a circular opening 23 is formed in the central portion of the first flat surface 25a. On the first flat surface 25a, male parts 21a and 21b as a pair of columnar projecting parts at positions symmetrical with respect to the opening 23 project and extend to the X direction positive side. In addition, between a pair of the male parts 21a and 21b, a pair of female parts 22a and 22b as arc-shaped slender strip-like depressed parts that extend along the shape of the first flat surface 25a are formed. That is, the male parts 21a and 21b and the female parts 22a and 22b are provided so as to be disposed on the same circumference. Note that, as shown in FIGS. 5G and 5H, the female parts 22a and 22b are formed so as to be extended to the X direction negative side relative to the first flat surface 25a. The second flat surface 25b also has the same shape as that of the first flat surface 25a. Herein, on the second flat surface 25b, a pair of male parts 21c and 21d and a pair of female parts 22c and 22d having the same shapes as those of the male parts 21a and 21b and the female parts 22a and 22b on the first flat surface 25a are formed. That is, the male parts 21c and 21d and the female parts 22c and 22d are also provided so as to be disposed on the same circumference. Note that the positions of the male parts 21a and 21b and the female parts 22a and 22b on the first flat surface 25a are different in phase from the positions of the male parts 21c and 21d and the female parts 22c and 22d on the second flat surface 25b by 90°.

With reference to FIG. 4, a description will be given of a coupling method when the medium pipe-type block 20 is detachably coupled to another medium pipe-type block 20′ as the second toy block having the same structure. Note that, similarly to the medium pipe-type block 20, another medium pipe-type block 20′ to be coupled to the medium pipe-type block 20 includes a flat surface 25c on which male parts 21e and 21f and female parts 22e and 22f are formed. Consequently, when the medium pipe-type block 20 is coupled to another medium pipe-type block 20′, the male parts 21c and 21d on the second flat surface 25b of the medium pipe-type block 20 are engaged with the female parts 22e and 22f on the flat surface 25c of another medium pipe-type block 20′. Herein, similarly to the small pipe-type block 10, the male parts 21c and 21d of the medium pipe-type block 20 are fitted into the female parts 22e and 22f of another medium pipe-type block 20′ such that it is difficult to detach the male parts 21c and 21d unless a specific pulling force is applied thereto. In addition, the male parts 21c and 21d of the medium pipe-type block 20 can move in the arc-shaped pattern along the extension direction of the female parts 22e and 22f in a state in which the male parts 21c and 21d are fitted into the female parts 22e and 22f of another medium pipe-type block 20′. On the other hand, similarly, the male parts 21e and 21f on the flat surface 25c of another medium pipe-type block 20′ are fitted into the female parts 22c and 22d on the second flat surface 25b of the medium pipe-type block 20. It is difficult to detach the male parts 21e and 21f of another medium pipe-type block 20′ from the female parts 22c and 22d of the medium pipe-type block 20 unless a specific pulling force is applied thereto, and the male parts 21e and 21f can move in the arc-shaped pattern circumferentially along the female parts 22c and 22d. Consequently, after the medium pipe-type block 20 and another medium pipe-type block 20′ are coupled to each other, it is possible to rotate the medium pipe-type block 20 and another medium pipe-type block 20′ relative to each other while maintaining the linked state. That is, the medium pipe-type block 20 is capable of appropriately changing the linking position relative to the flat surface 25c of another medium pipe-type block 20′.

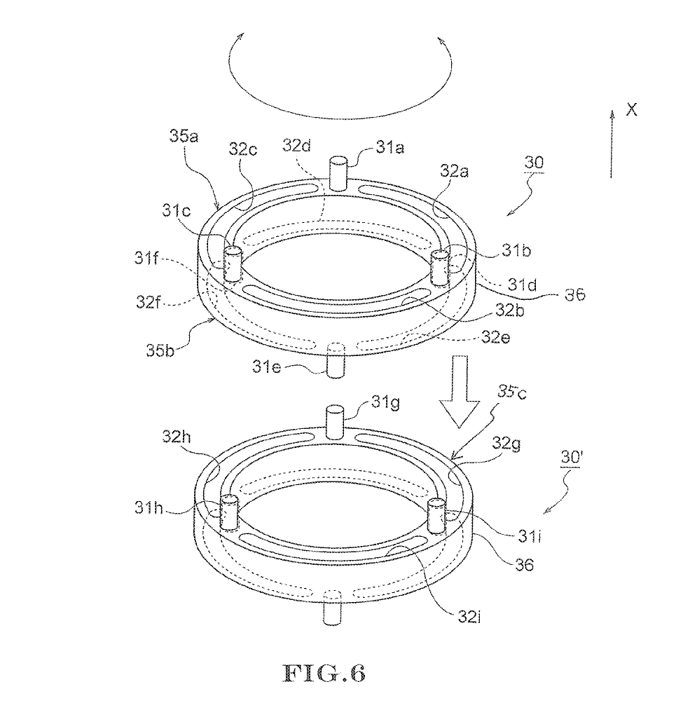

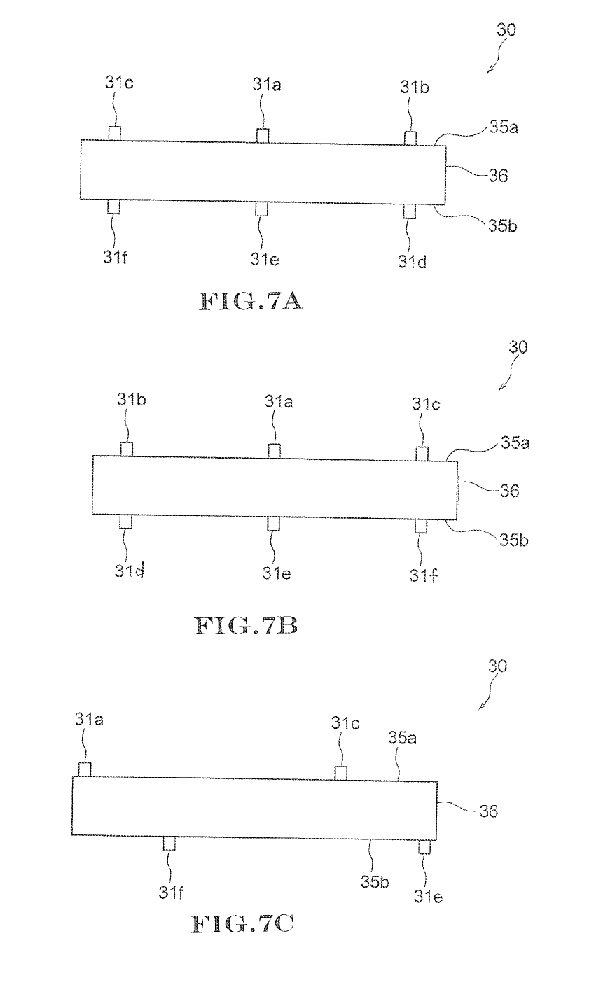

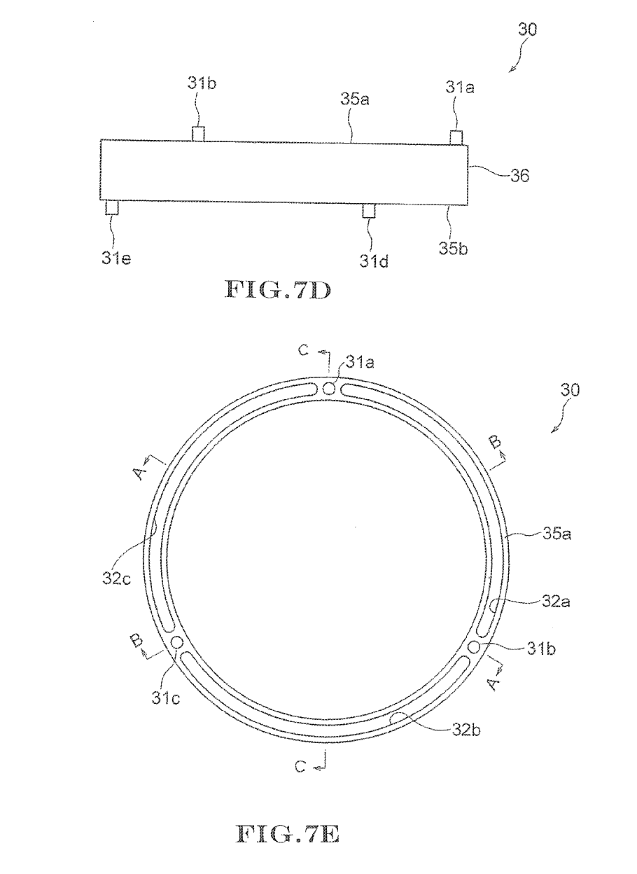

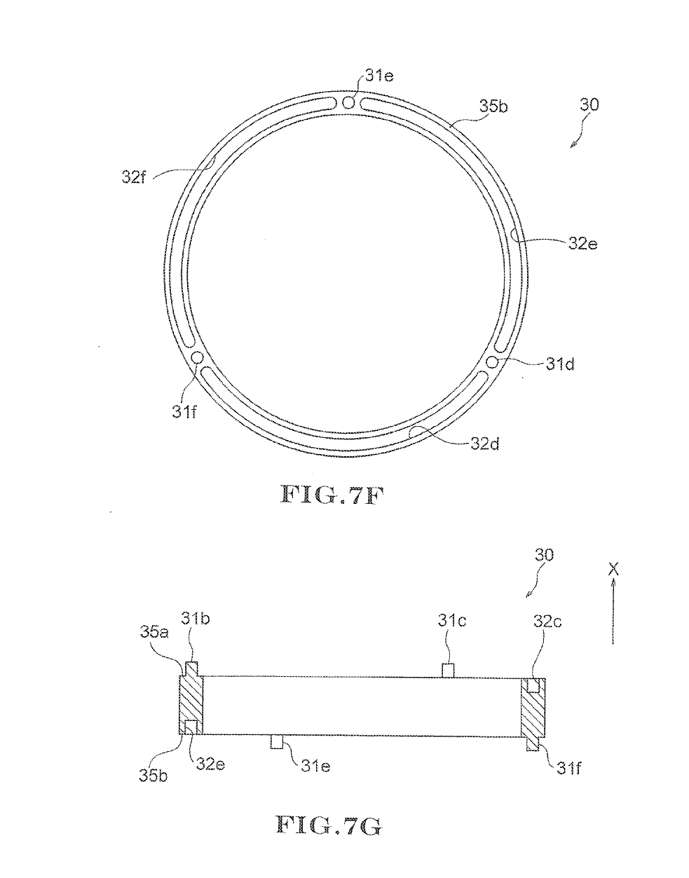

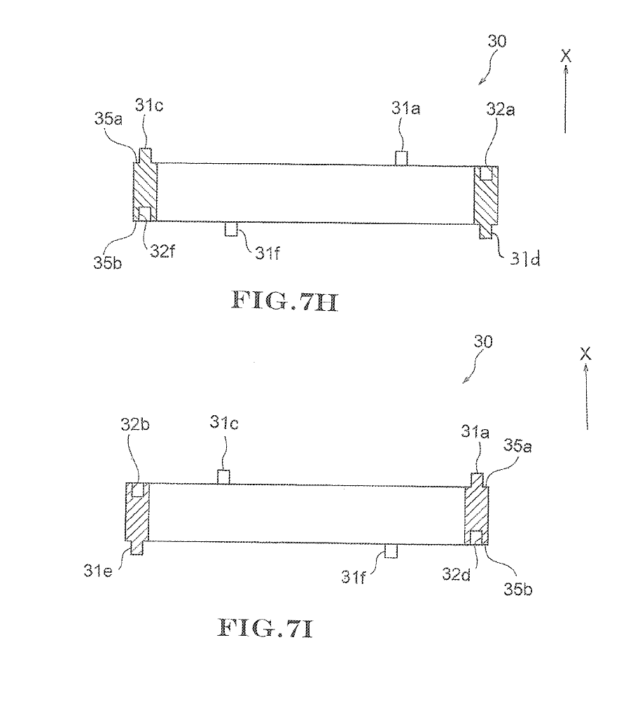

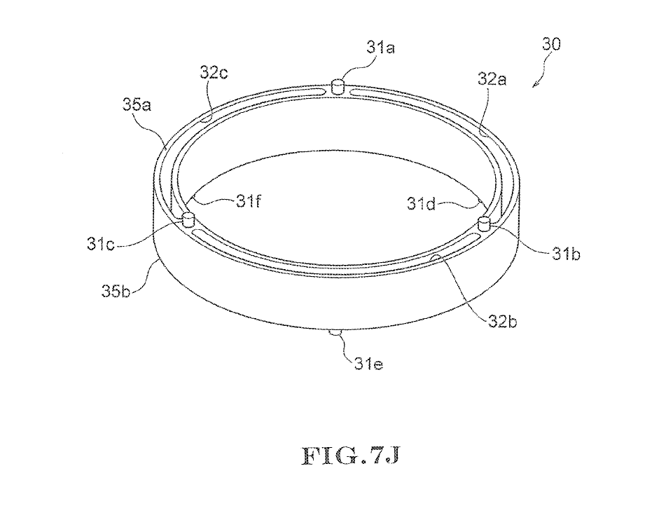

Further, a description will next be given of a large pipe-type block 30 as the toy block for the assembly toy based on FIG. 6 and FIGS. 7A to 7J. Note that a front view in FIG. 7A and a rear view in FIG. 7B are symmetrical.

The large pipe-type block 30 as the first toy block has an annular portion 36 having a substantially annular shape. At both ends of the annular portion 36, a substantially annular first flat surface 35a and a substantially annular second flat surface 35b are formed in parallel with each other. That is, the periphery of each of the first flat surface 35a and the second flat surface 35b is circular. Note that the size of the outer diameter of the first flat surface 35a or the second flat surface 35b of the large pipe-type block 30 is larger than the size of the outer diameter of the first flat surface 25a or the second flat surface 25b of the medium pipe-type block 20. Herein, on the first flat surface 35a, male parts 31a, 31b, and 31c as three columnar projecting parts are provided so as to be spaced apart from each other at intervals of 120°, and project and extend to the X direction positive side. In addition, between the male parts 31a, 31b, and 31c, female parts 32a, 32b, and 33c as three arc-shaped slender strip-like depressed parts are formed. As shown in FIGS. 7G to 7I, the female parts 32a, 32b, and 33c are formed so as to be indented in the X direction negative side relative to the first flat surface 25a. That is, the male parts 31a, 31b, and 31c and the female parts 32a, 32b, and 33c are provided so as to be disposed on the same circumference. The second flat surface 35b also has the same shape as that of the first flat surface 35a. Herein, on the second flat surface 35b, three male parts 31d, 31e, and 31f and three female parts 32d, 32e, and 32d having the same shapes as those of the male parts 31a, 31b, and 31c and the female parts 32a, 32b, and 32c on the first flat surface 35a are formed. That is, the male parts 31d, 31e, and 31f and the female parts 32d, 32e, and 32f are also provided so as to be disposed on the same circumference. Note that the positions of the male parts 31a, 31b, and 31c and the female parts 32a, 32b, and 32c on the first flat surface 35a are different in phase from the positions of the male parts 31d, 31e, and 31f and the female parts 32d, 32e, and 32f on the second flat surface 35b by 180°.

With reference to FIG. 6, a description will be given of a coupling method when the large pipe-type block 30 is detachably coupled to another large pipe-type block 30′ as the second toy block having the same structure. Note that, similarly to the large pipe-type block 30, another large pipe-type block 30′ to be coupled to the large pipe-type block 30 includes a flat surface 35c on which male parts 31g, 31h, and 31i and female parts 32g, 32h, and 32i are formed. Consequently, when the large pipe-type block 30 is coupled to another large pipe-type block 30′, the male parts 31d, 31e, and 31f on the second flat surface 35b of the large pipe-type block 30 are engaged with the female parts 32g, 32h, and 32i on the flat surface 35c of another large pipe-type block 30′. Herein, similarly to the small pipe-type block 10 or the medium pipe-type block 20, the male parts 31d, 31e, and 31f of the large pipe-type block 30 are fitted into the female parts 32g, 32h, and 32i of another large pipe-type block 30′ such that it is difficult to detach the male parts 31d, 31e, and 31f unless the specific pulling force is applied thereto. In addition, the male parts 31d, 31e, and 31f of the large pipe-type block 30 can move in the arc-shaped pattern circumferentially along the female parts 32g, 32h, and 32i in a state in which the male parts 31d, 31e, and 31f are fitted into the female parts 32g, 32h, and 32i of another large pipe-type block 30′. On the other hand, similarly, the male parts 31g, 31h, and 31i on the flat surface 35c of another large pipe-type block 30′ are fitted into the female parts 32d, 32e, and 32f on the second flat surface 35b of the large pipe-type block 30. It is difficult to detach the male parts 31g, 31h, and 31i of another large pipe-type block 30′ from the female parts 32d, 32e, and 32f of the large pipe-type block 30, and the male parts 31g, 31h, and 31i can move in the arc-shaped pattern circumferentially along the female parts 32d, 32e, and 32f. Consequently, after the large pipe-type block 30 and another large pipe-type block 30′ are coupled to each other, it is possible to rotate the large pipe-type block 30 and another large pipe-type block 30′ relative to each other while maintaining the linked state. That is, the large pipe-type block 30 is capable of appropriately changing the linking position relative to the flat surface 35c of another large pipe-type block 30′.

The coupling method of each of the small pipe-type block 10, the medium pipe-type block 20, and the large pipe-type block 30 is not limited to the above-described method in which the toy blocks of the same type are linked one by one.

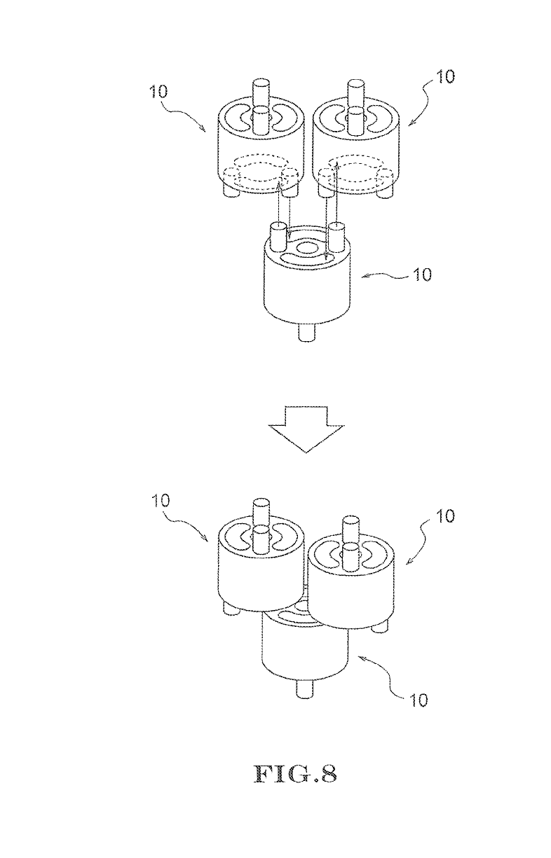

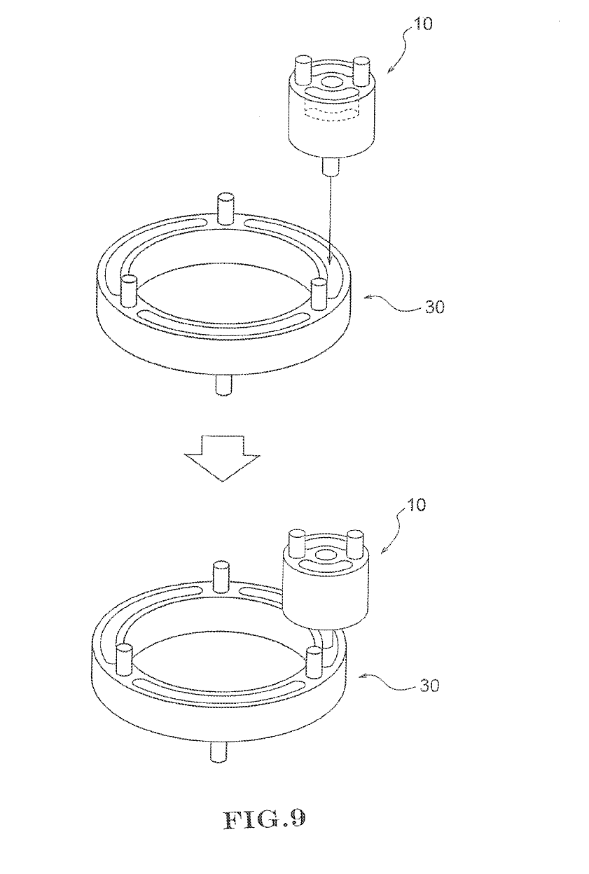

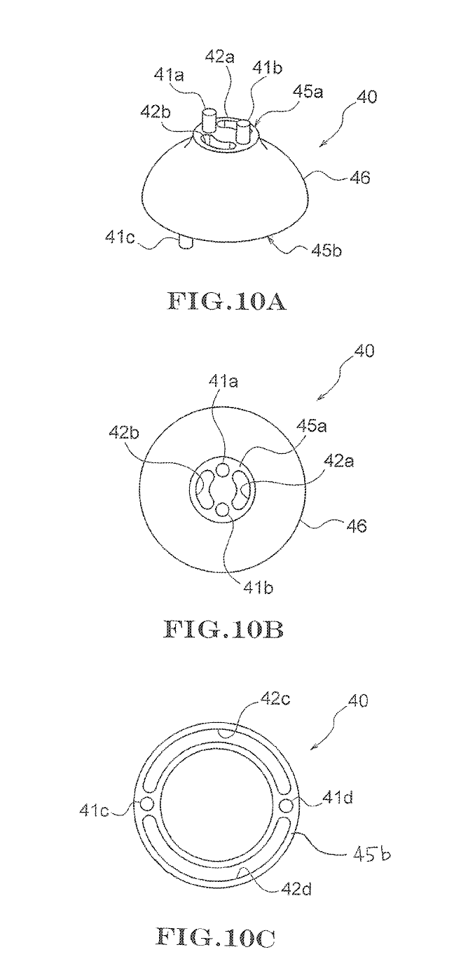

That is, as shown in FIG. 8, it is possible to engage the male parts and the female parts of three small pipe-type blocks 10 after displacing the center positions thereof from each other to thereby couple two of the small pipe-type blocks 10 to one flat surface of the remaining one of the small pipe-type blocks 10. In addition, as shown in FIG. 9, it is also possible to couple the small pipe-type block 10 to one of the flat surfaces of the large pipe-type block 30.

Note that the coupling method is not limited to the coupling method shown in each of FIGS. 8 and 9 and, the small pipe-type block 10 and the medium pipe-type block 20 may be linked together and the medium pipe-type block 20 and the large pipe-type block 30 may also be linked together.

Next, with reference to FIGS. 10A to 10C, a description will be given of a medium reducer-type block 40 as the toy block.

The medium reducer-type block 40 has a small-diameter flat surface 45a that has a circular periphery at one end, and a large-diameter flat surface 45b that has an outer diameter larger than that of the small-diameter flat surface 45a and has a circular periphery at the other end. As shown in FIG. 10B, the small-diameter flat surface 45a has the same structure as that of the first flat surface 15a or the second flat surface 15b of the small pipe-type block 10, and has male parts 41a and 41b as a pair of substantially columnar projecting parts and female parts 42a and 42b as a pair of arc-shaped strip-like depressed parts. Note that the male parts 41a and 41b project and extend vertically relative to the small-diameter flat surface 45a, and the female parts 42a and 42b are formed so as to be vertically indented in a direction opposite to the projection direction of the male parts 41a and 41b relative to the small-diameter flat surface 45a. In addition, as shown in FIG. 10C, the large-diameter flat surface 45b has a substantially annular shape having the same structure as that of the first flat surface 25a or the second flat surface 25b of the medium pipe-type block 20, and has male parts 41c and 41d as a pair of columnar projecting parts and female parts 42c and 42d as a pair of arc-shaped slender strip-like depressed parts. The male parts 41c and 41d also project and extend vertically relative to the large-diameter flat surface 45b, and the female parts 42c and 42d are formed so as to be vertically indented in a direction opposite to the projection direction of the male parts 41c and 41d relative to the large-diameter flat surface 45b. In addition, as shown in FIG. 10A, a side surface 46 of the medium reducer-type block 40 has a smooth substantially dome-like shape that is spread from the small-diameter flat surface 45a toward the large-diameter flat surface 45b. Consequently, the small pipe-type block 10 can be linked to the small-diameter flat surface 45a of the medium reducer-type block 40, and the medium pipe-type block 20 can be linked to the large-diameter flat surface 45b. That is, the small pipe-type block 10 and the medium pipe-type block 20 that have different diameters are smoothly connected via the medium reducer-type block 40.

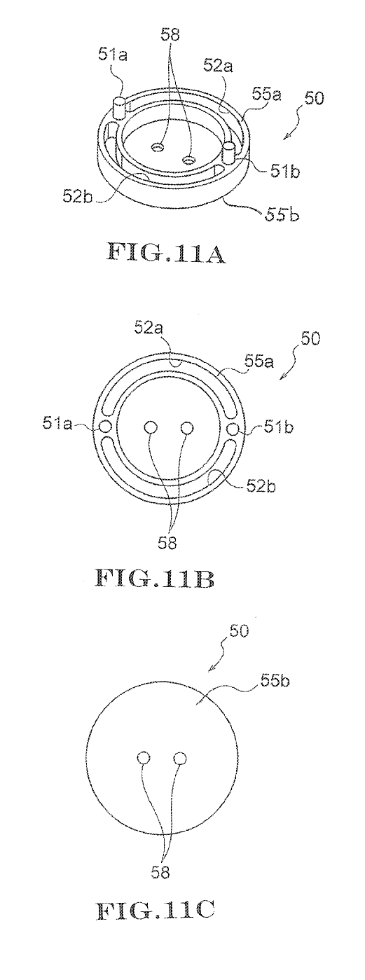

Next, with reference to FIGS. 11A to 11C, a description will be given of a medium cap-type block 50 as the toy block.

The medium cap-type block 50 has an annular flat surface 55a having an annular shape at one end, and a circular flat surface 55b at the other end. The annular flat surface 55a has the same structure as that of the first flat surface 25a or the second flat surface 25b of the medium pipe-type block 20, and has male parts 51a and 51b as a pair of columnar projecting parts and female parts 52a and 52b as a pair of arc-shaped strip-like depressed parts. Note that the male parts 51a and 51b project and extend vertically relative to the annular flat surface 55a, and the female parts 52a and 52b are formed so as to be vertically indented in a direction opposite to the projection direction of the male parts 51a and 51b relative to the annular flat surface 55a. In addition, two holes 58 are formed in the central portion of the medium cap-type block 50.

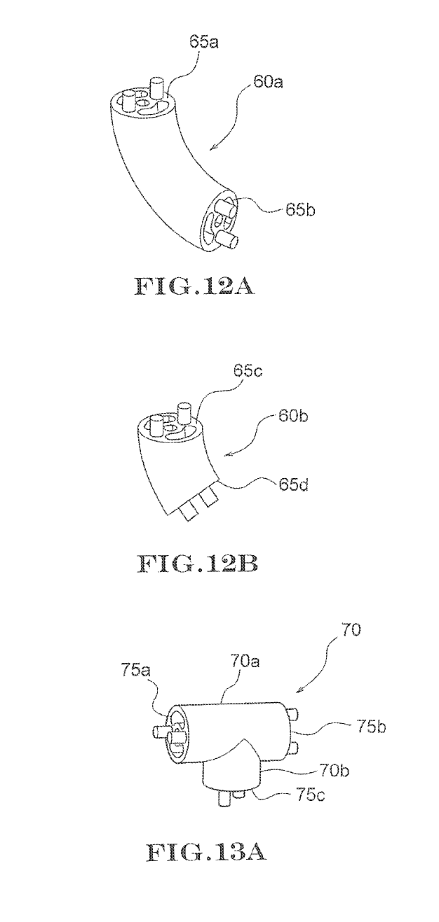

Next, with reference to FIGS. 12A and 12B, a description will be given of a small elbow-type (90 degrees) block 60a and a small elbow-type (45 degrees) block 60b as the toy blocks.

The small elbow-type (90 degrees) block 60a in FIG. 12A has a tubular shape that is bent 90 degrees, and flat surfaces 65a and 65b each having male parts and female parts that have the same structures as those of the male parts and the female parts on the first flat surface 15a or the second flat surface 15b of the small pipe-type block 10 are formed at both ends of the small elbow-type block 60a. That is, the flat surfaces 65a and 65b are disposed in different directions that are perpendicular to each other. The length of the small elbow-type (45 degrees) block 60b shown in FIG. 12B is shorter than the length of the small elbow-type (90 degrees) block 60a, and the small elbow-type block 60b has a tubular shape that is bent 45 degrees. At both ends of the small elbow-type (45 degrees) block 60b, flat surfaces 65c and 65d each having male parts and female parts that have the same structures as those of the male parts and the female parts on the first flat surface 15a or the second flat surface 15b of the small pipe-type block 10 are formed. That is, the flat surface 65c and the flat surface 65d are disposed so as to extend in different directions that form an angle of 45 degrees.

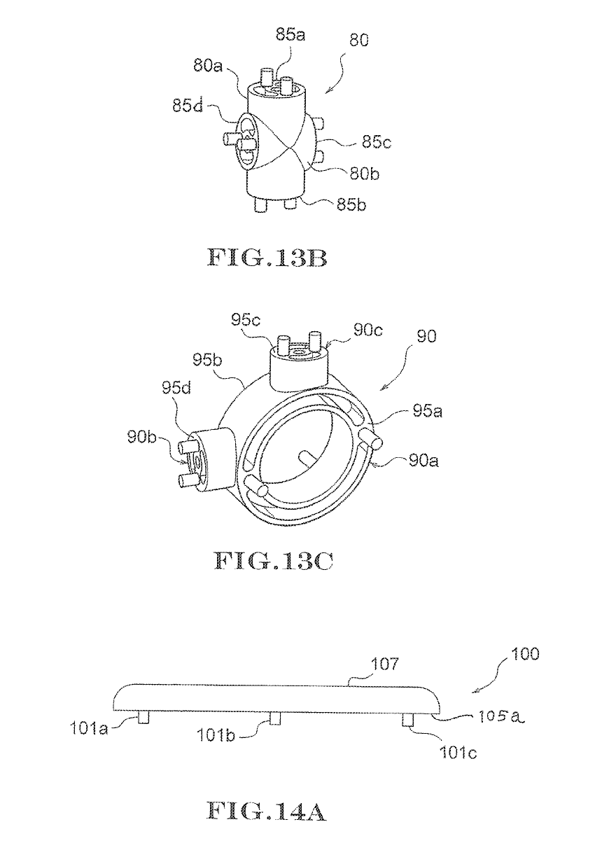

Further, next, with reference to FIGS. 13A to 13C, a description will be given of the toy blocks having other shapes.

First, the toy block shown in FIG. 13A is a small tee-type block 70, and the small tee-type block 70 has a shape in which a cylindrical part 70a and another cylindrical part 70b are combined at right angles and part of the cylindrical part 70b is buried in the center of the cylindrical part 70a. At both ends of the cylindrical part 70a, a first flat surface 75a and a second flat surface 75b that are disposed in parallel with each other are formed. In addition, at an end of the cylindrical part 70b, a third flat surface 75c is formed. That is, the first flat surface 75a or the second flat surface 75b and the third flat surface 75c are disposed in different directions that are perpendicular to each other. Note that each of the first flat surface 75a, the second flat surface 75b, and the third flat surface 75c have male parts and female parts having the same structures as those of the male parts and the female parts on the first flat surface 15a or the second flat surface 15b of the small pipe-type block 10.

The toy block shown in FIG. 13B is a small cross-type (180 degrees) block 80, and the small cross-type block 80 has a cross shape in which a cylindrical part 80a and another cylindrical part 80b are combined at right angles at central portions thereof. Flat surfaces 85a and 85b that are disposed in parallel with each other are formed at both ends of the cylindrical part 80a, and flat surfaces 85c and 85d are formed at both ends of the cylindrical part 80b. That is, the flat surfaces 85a and 85b of the cylindrical part 80a and the flat surfaces 85c and 85d of the cylindrical part 80b are disposed in different directions that are perpendicular to each other. Herein, each of the flat surfaces 85a, 85b, 85c, and 85d of the small cross-type (180 degrees) block 80 have male parts and female parts having the same structures as those of the male parts and the female parts on the first flat surface 15a or the second flat surface 15b of the small pipe-type block 10.

The toy block shown in FIG. 13C is a medium cross-type (90 degrees) block 90, and two cylindrical parts 90b and 90c are provided so as to be spaced apart from each other at an interval of 90 degrees on a peripheral surface of an annular part 90a having the same structure as that of the medium pipe-type block 20. At both ends of the annular part 90a, flat surfaces 95a and 95b each having male parts and female parts that have the same structures as those of the male parts and the female parts on the first flat surface 25a or 25b of the medium pipe-type block 20 are formed. In addition, also at ends of the cylindrical parts 90b and 90c, flat surfaces 95c and 95d each having male parts and female parts that have the same structures as those of the male parts and the female parts on the first flat surface 15a or 15b of the small pipe-type block 10 are formed. That is, the flat surface 95a, the flat surface 95b, and the flat surfaces 95c and 95d are disposed in different directions that are perpendicular to each other.

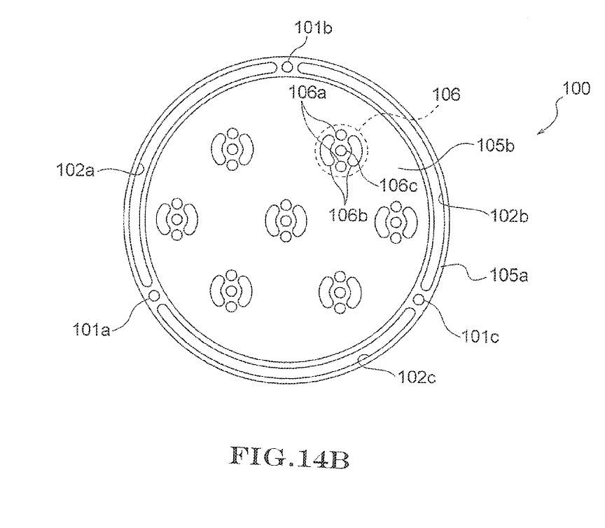

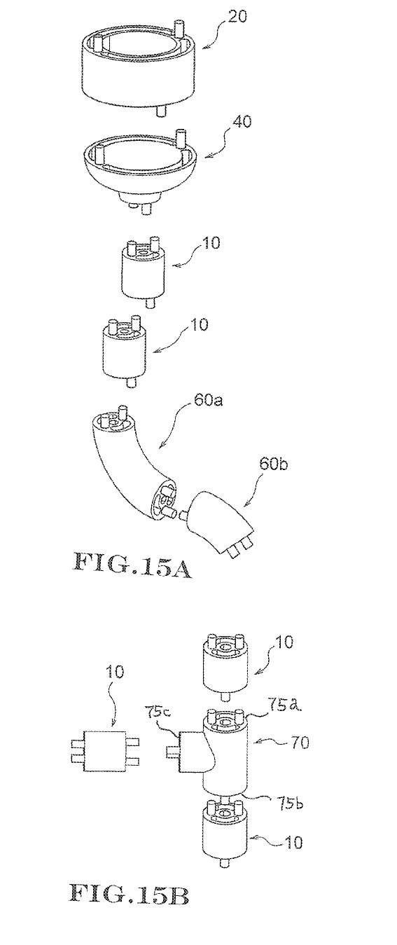

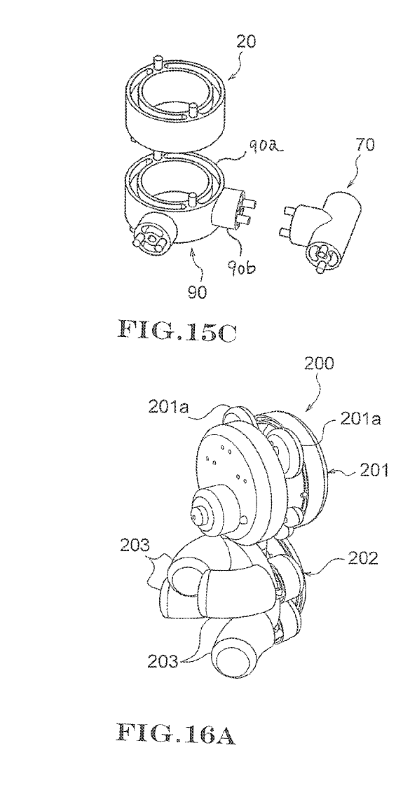

Next, with reference to FIGS. 14A and 14B, a description will be given of a large cap-type (subtype) block 100 as a modification of the cap-type block formed with the male parts and the female parts only on one surface such as the medium cap-type block 50 shown in each of FIGS. 11A to 11C.

The large cap-type (subtype) block 100 is a substantially dish-shaped toy block, and has an annular flat surface 105a having an annular shape and a bottom flat surface 105b surrounded by the annular flat surface 105a on one surface. A surface opposite to the bottom flat surface 105b serves as a lid surface 107. The annular flat surface 105a has the same shape as that of the first flat surface 35a or the second flat surface 35b of the large pipe-type block 30, and has three male parts 101a, 101b, and 101c and three female parts 102a, 102b, and 102c that have the same structures as those of the male parts and the female parts on the first flat surface 35a or the second flat surface 35b thereof. That is, the male parts 101a, 101b, and 101c project and extend vertically relative to the annular flat surface 105a, and the female parts 102a, 102b, and 102c are formed so as to be vertically indented in a direction opposite to the projection direction of the male parts 101a, 101b, and 101c relative to the annular flat surface 105a. In addition, the male parts 101a, 101b, and 101c and the female parts 102a, 102b, and 102c are provided on the same circumference.

On the bottom flat surface 105b, seven attachment parts 106 each having, as a unit, a pair of male parts 106a, a pair of female parts 106b, and an attachment hole 106c are formed. The pair of male parts 106a and the pair of female parts 106b of the attachment part 106 have the same shapes as those of the male parts 11a to 11d and the female parts 12a to 12d of the first flat surface 15a or the second flat surface 15b of the small pipe-type block 10. That is, the pair of male parts 106a project and extend vertically relative to the bottom flat surface 105b, and the pair of female parts 106b are formed so as to be vertically indented in a direction opposite to the extension direction of the male parts 106a relative to the bottom flat surface 105b. The pair of male parts 106a and the pair of female parts 106b of each attachment part 106 are provided on the same circumference.

Next, with reference to FIGS. 15A to 15C, a description will be given of an example of an assembly method of various toy blocks.

In FIG. 15A, the medium pipe-type block 20, the medium reducer-type block 40, two small pipe-type blocks 10, the small elbow-type (90 degrees) block 60a, and the small elbow-type (45 degrees) block 60b are coupled together in this order from the top. Note that the two small pipe-type blocks 10 are coupled to each other with their center positions displaced from each other.

FIG. 15B is an example in which the small pipe-type block 10 is coupled to each of the three flat surfaces 75a, 75b, and 75c of the small tee-type block 70.

FIG. 15C is an example in which the medium pipe-type block 20 is coupled to the annular part 90a of the medium cross-type (90 degrees) block 90, and the small tee-type block 70 is coupled to the cylindrical part 90b.

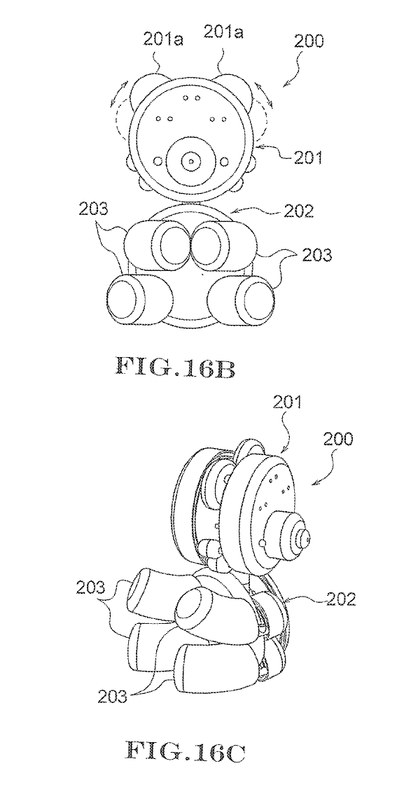

In addition, it is also possible to form a bear-like doll 200 as shown in FIG. 16A by combining various toy blocks.

The doll 200 includes a face part 201, a body 202 that is connected to the face part 201, and four legs 203 that are attached to the body 202. In addition, a pair of ears 201a are attached to the face part 201. As shown in FIG. 16B, it is possible to move the ears 201a of the doll 200 relative to the face part 201. In addition, as shown in FIG. 16C, it is possible to change the angle and orientation of the face part 201 or the leg 203 of the doll 200.

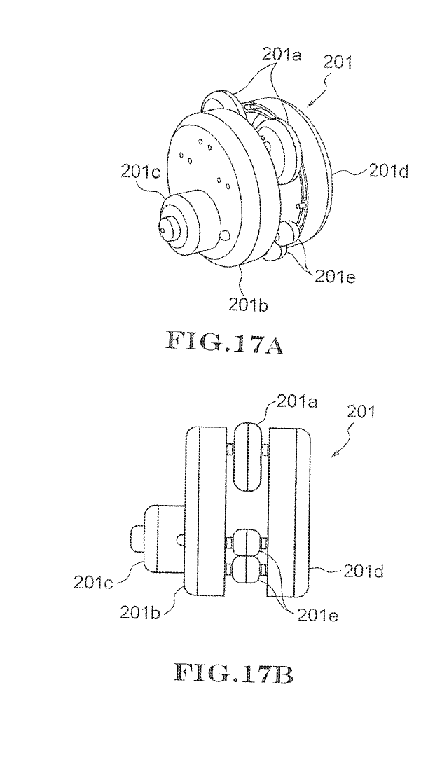

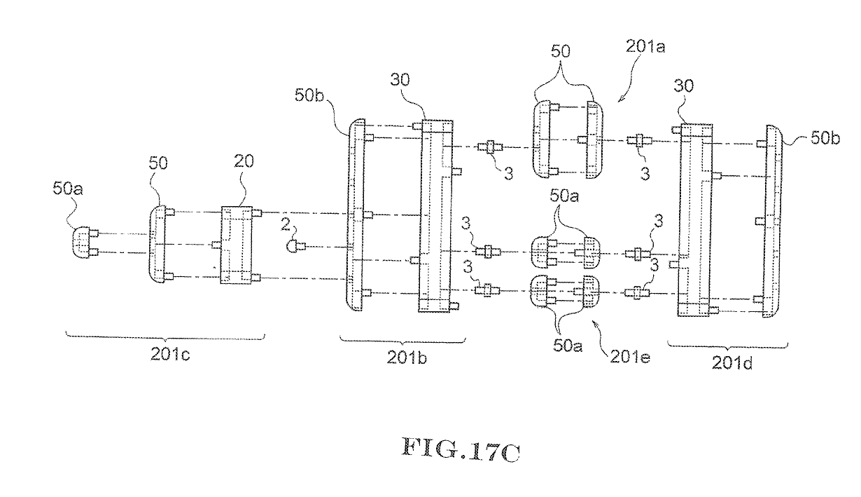

A description will be given of the structure of the face part 201 of the bear-like doll 200 by using FIGS. 17A to 17C.

As shown in FIGS. 17A and 17B, the face part 201 includes the ears 201a, a substantially columnar face front part 201b that is attached to the front side beyond the ears 201a, and a substantially columnar face rear part 201d that is attached to the rear side behind the ears 201a. Further, in addition to them, the face part 201 includes a nose 201c that is attached to the lower half of the face front part 201b, and spacers 201e that are provided between the face front part 201b and the face rear part 201d.

A description will be given of the detailed structure of each portion of the face part 201 with reference to FIG. 17C.

First, the ear 201a is obtained by linking two medium cap-type blocks 50 together. Each of the face front part 201b and the face rear part 201d is obtained by linking a large cap-type block 50b larger in diameter than the medium cap-type block 50 to the large pipe-type block 30. A pin 2 that represents an eye of the bear is inserted into a linking hole of the large cap-type block 50b of the face front part 201b. The nose 201c is obtained by combining the medium pipe-type block 20, the medium cap-type block 50, and a small cap-type block 50a smaller in diameter than the medium cap-type block 50. Each spacer 201e is obtained by combining two small cap-type blocks 50a. The ear 201a and the spacer 201e between the face front part 201b and the face rear part 201d are attached to the large pipe-type blocks 30 at the front and rear thereof using pins 3.

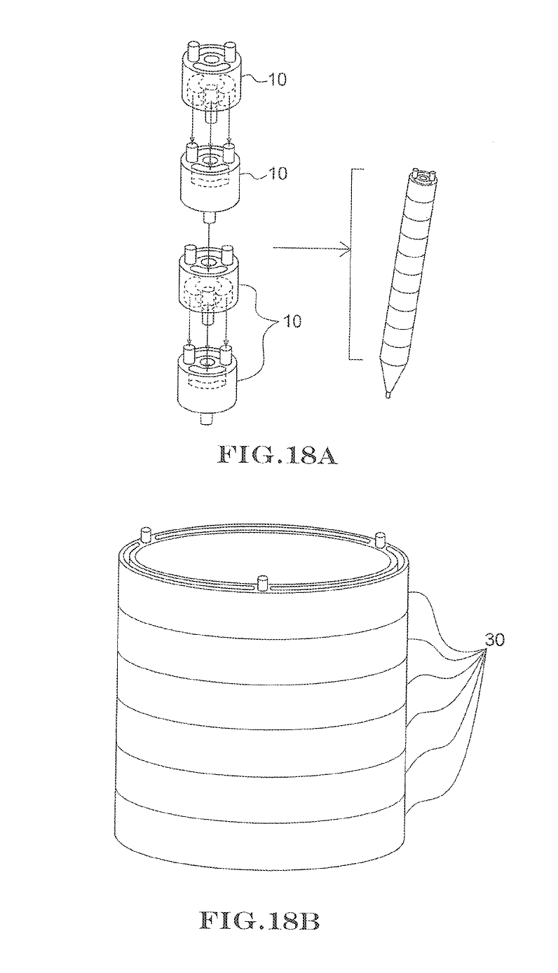

Further, as shown in FIG. 18A, it is also possible to form a structure of a mechanical pencil by linking a plurality of the small pipe-type blocks 10 together. In addition, as shown in FIG. 18B, it is also possible to form general merchandise such as a pouch by stacking the large pipe-type blocks 30.

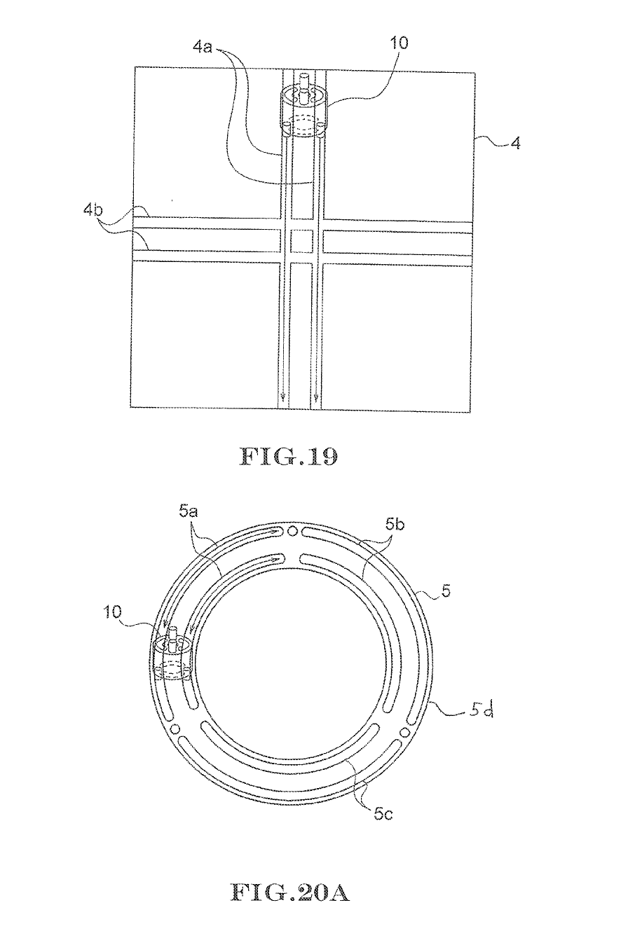

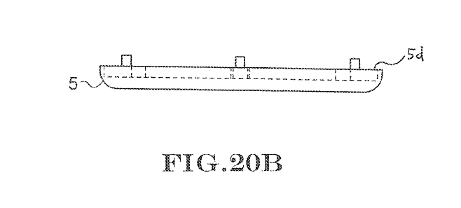

Furthermore, as shown in FIG. 19, it is also possible to form a dynamic structure that freely moves the small pipe-type block 10 linearly by fitting the male parts of the small pipe-type block 10 into rail-like grooves 4a or 4b that are formed in a plate-like block 4 such that the grooves 4a and 4b are orthogonal to each other. In addition, as shown in FIGS. 20A and 20B, it is also possible to move the small pipe-type block 10 in an arc-shaped pattern by fitting the male parts of the small pipe-type block 10 into three pairs of rail-like grooves 5a, 5b, and 5c that are formed in an annular edge part 5d of a dish-shaped block 5.

With the foregoing arrangement, in the assembly toy according to the embodiment, the male part and the female part formed on the flat surface of the toy block are provided on the same circumference, and hence it is possible to link the flat surfaces as the linking surfaces of the toy blocks together at a variety of angles as compared with the case where the male part and the female part are linearly disposed. Accordingly, flexibility in forming by combining the toy blocks is increased.

In addition, in the toy block for the conventional assembly toy described in PTL 1, after a specific shape is formed by linking the depressed and projecting parts of the toy block to the depressed and projecting parts of another toy block, it is not possible to rotate each toy block or displace the relative positions of the toy blocks. However, in the assembly toy according to the embodiment, it is possible to rotate one toy block relative to another toy block while maintaining the state in which the toy blocks are linked together. Accordingly, even after a plurality of the toy blocks are assembled into a specific shape, it is possible to appropriately change the shape of the detail, and the flexibility in forming is further increased.

Note that the toy block is capable of not only the rotational movement but also linear movement or arc-shaped movement along the rail-like grooves of another member as shown in FIG. 19 and FIG. 20A, and hence it is possible to form a dynamic structure predicated on the capability of partial movement.

Further, in the assembly toy according to the embodiment, each toy block includes the male part and the female part on one flat surface, and hence a user can link another toy block from any flat surface without considering the orientation of the toy block. Accordingly, a linking member for linking the toy blocks together is not necessary, and it is possible to reduce the number of components of the entire assembly toy.

In addition, as shown in FIGS. 1 to 14B, the male part of each of the various toy blocks is the columnar projecting part, the female part thereof is the depressed part formed into the strip-like shape, and the male part is fittable into the female part in the width direction of the female part, and hence it is difficult to detach the toy blocks from each other unless the specific pulling force is applied thereto.

Further, the female part is the arc-shaped depressed part, whereby it is possible to cause the male part and the female part of the toy blocks to fit together to allow smooth rotational movement and, after the user assembles the toy blocks, a twist operation for adjusting the shape of the assembled toy blocks is allowed.

Further, as shown in FIGS. 1 to 14B, the periphery of the flat surface of each of the various toy blocks is circular, and hence it becomes possible to create a round form as a whole such as the bear-like doll 200 shown in FIG. 16A, the mechanical pencil shown in FIG. 18A, or the pouch shown in FIG. 18B.

In addition, the medium reducer-type block 40 shown in FIG. 10A or the medium cross-type (90 degrees) block shown in FIG. 13C has two or more circular flat surfaces having different outer diameters, and it is thereby possible to connect the toy blocks having different diameters to each other. In addition, the side surface 46 of the medium reducer-type block 40 is a smoothly curved surface, and hence it is possible to smoothly connect the toy blocks having different diameters via the medium reducer-type block 40.

Further, each of the various toy blocks has a pair of the flat surfaces that are disposed in parallel with each other, and hence it is possible to linearly link a plurality of the toy blocks together.

Furthermore, the small elbow-type (90 degrees) block 60a shown in FIG. 12A, the small elbow-type (45 degrees) 60b shown in FIG. 12B, the small tee-type block 70 shown in FIG. 13A, the small cross-type (180 degrees) block 80 shown in FIG. 13B, or the medium cross-type (90 degrees) block 90 shown in FIG. 13C has two or more flat surfaces disposed in different directions. With this, it is possible to link the toy blocks in various directions to allow more diversified three-dimensional forming.

Note that, in the embodiment, the male part of the toy block is the columnar projecting part, but the male part may also have a prism shape or other prismatic shapes. Further, the shape of the flat surface formed in the toy block is not limited to the circular shape and may also be an oblong shape.

In addition, when the various toy blocks shown in FIGS. 1 to 14B are assembled in the manners shown in FIGS. 15A to 15C, an optical fiber may be provided in a through hole or an opening formed in the toy block. With this, it is possible to cause the structure formed by a plurality of the toy blocks to emit light by causing the optical fiber to emit light.

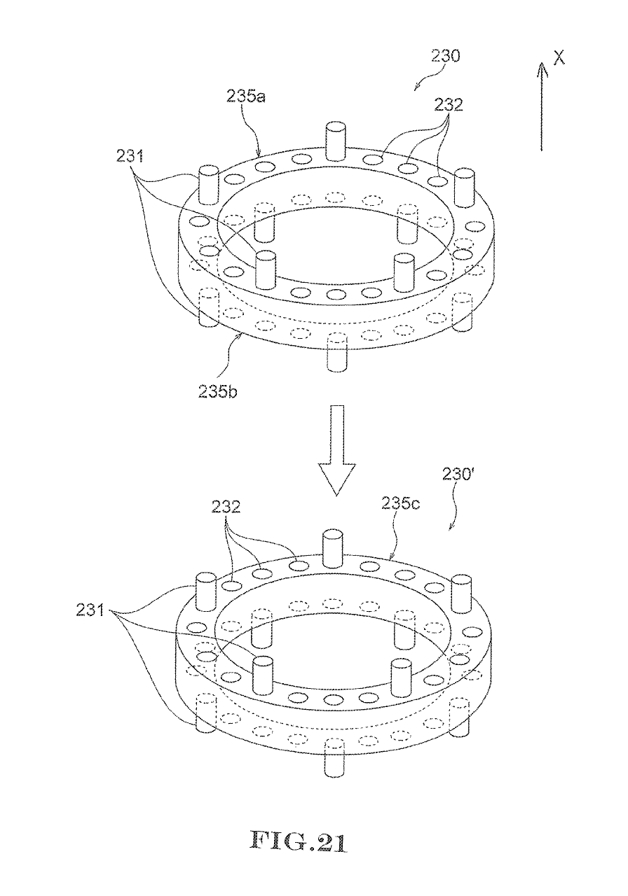

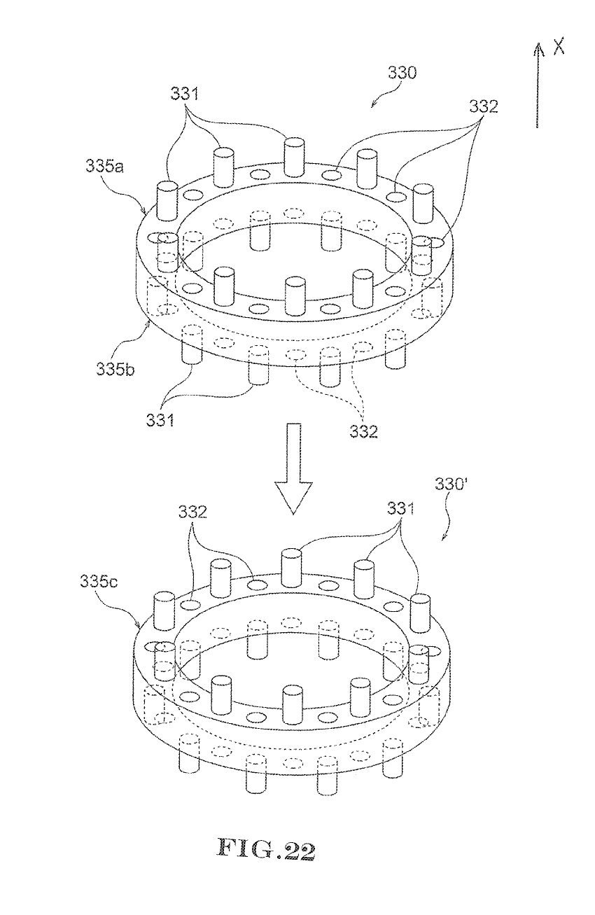

Further, the shape of the female part formed in the toy block for the assembly toy according to the invention is not limited to the slender strip-like groove, and the female part may also be a depressed part having a circular cross section, as shown in FIG. 21 or 22.

Herein, to describe a toy block 230 shown in FIG. 21, at both ends of the substantially cylindrical toy block 230, a substantially annular first flat surface 235a and a substantially annular second flat surface 235b are formed in parallel with each other. That is, the periphery of each of the first flat surface 235a and the second flat surface 235b is circular. In addition, on the first flat surface 235a, male parts 231 as five columnar projecting parts are provided so as to be spaced apart from each other at regular intervals along the shape of the first flat surface 235a, and project and extend to the X direction positive side. In addition, between the male parts 231, three female parts 232 as depressed parts each having a circular cross section are formed so as to be indented in the X direction negative side. That is, on the first flat surface 235a, an arrangement of one male part 231 and three female parts 232 is disposed five times repeatedly along the circumferential direction of the first flat surface 235a. Consequently, on the first flat surface 235a, a total of fifteen depressed parts are provided. Five male parts 231 and fifteen female parts 232 are provided so as to be disposed on the same circumference. The second flat surface 235b also has the same shape as that of the first flat surface 235a, and has five male parts 231 and fifteen female parts 232.

The toy block 230 as the first toy block can be coupled to another toy block 230′ as the second toy block having the same structure. When the two toy blocks 230 and 230′ are coupled to each other, the male part 231 on the second flat surface 235b of the first toy block 230 is detachably fitted into the female part 232 on a flat surface 235c of the second toy block 230′. Further, the male part 231 on the flat surface 235c of the second toy block 230′ is detachably fitted into the female part 232 on the second flat surface 235b of the first toy block 230. Herein, when orientations allow the male parts 231 and the female parts 232 of the two toy blocks 230 and 230′ to fit together, the first toy block 230 may be coupled to the second toy block 230′ at any angle.

To describe a toy block 330 shown in FIG. 22, at both ends of the substantially cylindrical toy block 330, a substantially annular first flat surface 335a and a substantially annular second flat surface 335b are formed in parallel with each other. That is, the periphery of each of the first flat surface 335a and the second flat surface 335b is circular. On the first flat surface 335a, male parts 331 as ten columnar projecting parts and ten female parts 332 as depressed parts each having a circular cross section are alternately disposed side by side along the shape of the first flat surface 335a. Herein, the male part 331 projects and extends in the X direction positive side, and the female part 332 is formed so as to be indented in the X direction negative side. Consequently, ten male parts 331 and ten female parts 332 are provided so as to be disposed on the same circumference. The second flat surface 335b also has the same shape as that of the first flat surface 335a, and has ten male parts 331 and ten female parts 332.

The toy block 330 as the first toy block can be coupled to a toy block 330′ as the second toy block having the same structure. When the two toy blocks 330 and 330′ are coupled to each other, the male part 331 on the second flat surface 335b of the first toy block 330 is detachably fitted into the female part 332 on a flat surface 335c of the second toy block 330′. Further, the male part 331 on the flat surface 335c of the second toy block 330′ is detachably fitted into the female part 332 on the second flat surface 335b of the first toy block 330. Herein, when orientations allow the male parts 331 and the female parts 332 of the two toy blocks 330 and 330′ to fit together, the first toy block 330 may be coupled to the flat surface 335c of the second toy block 330′ at any angle.

With the foregoing arrangement, in the toy block 230 shown in FIG. 21 and the toy block 330 shown in FIG. 22, the male part and the female part are provided on the same circumference, and hence it is possible to link the flat surfaces of the toy blocks together at a variety of angles. In addition, the toy blocks are detachably linked together, and hence it is possible to detach the toy blocks that are once coupled together from each other and couple them together again at a different angle to change the linking position.

In addition, in the toy block 230 shown in FIG. 21, on the first flat surface 235a or the second flat surface 235b, the arrangement of one male part 231 and three female parts 232 larger in number than the male part 231 is disposed five times repeatedly. Accordingly, it is possible to link the first toy block 330 to the second toy block 330′ at a greater variety of angles while changing the angle gradually.

Note that the arrangement of the male part 231 and the female parts 232 provided on the first flat surface 235a or the second flat surface 235b of the toy block 230 is not limited to the arrangement of the combination of one male part and a plurality of the female parts larger in number than the male part. That is, on the first flat surface 235a or the second flat surface 235b of the toy block 230, the arrangement constituted by two or more male parts and a plurality of the female parts larger in number than the male parts may be repeatedly provided.

In addition, in the toy block 330 shown in FIG. 22 as well, the male parts 331 and the female parts 332 are alternately disposed on the same circumference, and hence, similarly to the toy block 230, it is possible to link the toy blocks 330 together at a variety of angles while adjusting the angle gradually.

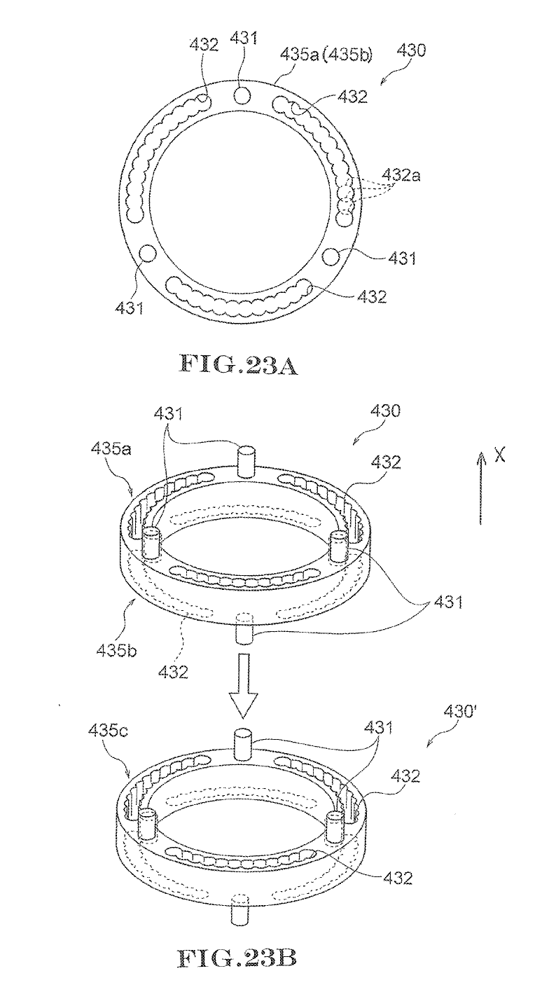

In addition, as shown in FIGS. 23A and 23B, the shape of the female part formed in the toy block for the assembly toy according to the invention may also be a depressed part having a strip-like shape in which a plurality of circles having the same diameter are consecutively formed on the circumference so as to overlap each other.

Specifically, as shown in FIG. 23B, at both ends of a substantially cylindrical toy block 430, a substantially annular first flat surface 435a and a substantially annular second flat surface 435b shown in FIG. 23A are formed in parallel with each other. That is, the periphery of each of the first flat surface 435a and the second flat surface 435b is circular. In addition, on the first flat surface 435a, male parts 431 as three columnar projecting parts are provided so as to be spaced apart from each other at intervals of 120° along the shape of the first flat surface 435a, and project and extend to the X direction positive side. Between the three male parts 431, female parts 432 as strip-like depressed parts are formed. Each female part 432 is a depressed part having a strip-like shape in which twelve circles 432a having the same diameter are consecutively formed on the circumference so as to overlap each other, and is formed so as to be indented to the X direction negative side. Each circle 432a is formed so as to allow the male part 431 to detachably fit into the circle 432a. The second flat surface 435b also has the same shape as that of the first flat surface 435a, and has three male parts 431 and three female parts 432.

The toy block 430 as the first toy block can be coupled to another toy block 430′ as the second toy block having the same structure. When the two toy blocks 430 and 430′ are coupled to each other, the male part 431 on the second flat surface 435b of the first toy block 430 is detachably fitted into the female part 432 on a flat surface 435c of the second toy block 430′. Further, the male part 431 on the flat surface 435c of the second toy block 430′ is detachably fitted into the female part 432 on the second flat surface 435b of the first toy block 430. Herein, the female part 432 has the shape in which twelve circles 432a are consecutively formed, and hence the male part 431 is fitted at the position corresponding to each circle 432a, and the position thereof is fixed. On the other hand, in the case where a force is applied such that the first toy block 430 that is coupled to the second toy block 430′ is rotated relative to the second toy block 430′, each male part 431 can move along the extension direction of the female part 432 in a state in which each male part 431 is fitted into each female part 432. That is, the male part 431 fitted at the position corresponding to the circle 432a of the female part 432 can move to the position corresponding to another circle 432a adjacent to the above circle 432a by application of a force at a predetermined level or higher in the extension direction of the female part 432 to the male part 431.

Consequently, in the toy block 430 shown in FIGS. 23A and 23B, the male part 431 and the female part 432 are provided on the same circumference, and hence it is possible to link the second flat surface 435b of the first toy block 430 to the flat surface 435c of the second toy block 430′ at a variety of angles.

In addition, the male part 431 of the toy block 430 can move in the extension direction of the female part 432 in the state in which the male part 431 is fitted into the female part 432. Accordingly, the first toy block 430 can rotate relative to the second toy block 430′ while a state in which the first toy block 430 is linked to the second toy block 430′ is maintained, and change the linking position.

Further, the male part 431 is fixed to the position corresponding to the circle 432a of the female part 432 unless a force at a specific level or higher is applied to the toy block 430, and hence the first toy block 430 and the second toy block 430′ can be stably coupled to each other.

### REFERENCE SIGNS LIST

11a to 11f, 21a to 21f, 31a to 31i, 41a to 41d, 51a, 51b, 101a to 101c, 106a, 231, 331, 431 Male part
12a to 12f, 22a to 22f, 32a to 32i, 42a to 42d, 52a, 52b, 102a to 102c, 106b, 232, 332, 432 Female part
15a, 25a, 35a, 75a, 235a, 335a, 435a First flat surface (flat surface)
10 Small pipe-type block (first toy block)
10′ Small pipe-type block (second toy block)
15b, 25b, 35b, 75b, 235b, 335b, 435b Second flat surface (flat surface)
15c, 25c, 35c, 235c, 335c, 435c Flat surface
20 Medium pipe-type block (first toy block)
20′ Medium pipe-type block (second toy block)
30 Large pipe-type block (first toy block)
30′ Large pipe-type block (second toy block)
40 Medium reducer-type block (toy block)
45a Small-diameter flat surface (flat surface)
45b Large-diameter flat surface (flat surface)
50 Medium cap-type block (toy block)
50a Small cap-type block (toy block)
50b Large cap-type block (toy block)
55a Annular flat surface (flat surface)
60a Small elbow-type (90 degrees) block (toy block)
60b Small elbow-type (45 degrees) block (toy block)
65a to 65d, 85a to 85d, 95a to 95d Flat surface
70 Small tee-type block (toy block)
75c Third flat surface (flat surface)
80 Small cross-type (180 degrees) block (toy block)
90 Medium cross-type (90 degrees) block (toy block)
100 Large cap-type (subtype) block (toy block)
105a Annular flat surface (flat surface)
105b Bottom flat surface (flat surface)
230, 330, 430 First toy block
230′, 330′, 430′ Second toy block

1-5. (canceled)

6. An assembly toy having a first toy block and a second toy block linkable to each other, wherein
each of the toy blocks includes:
at least two flat surfaces;
at least two columnar projecting parts that project and extend vertically from each of the flat surfaces; and
at least two arc-shaped strip-like depressed parts that are formed so as to be vertically indented from each of the flat surfaces in a direction opposite to a projection direction of the projecting parts,
the projecting parts and the depressed parts are provided on the same circumference and are alternately disposed on the flat surface,
the circumference has a same diameter in each of the flat surfaces,
the projecting parts are detachably fittable into the depressed parts in a width direction of each of the depressed parts, and
the projecting parts of the first toy block and the second toy block move in an arc-shaped pattern along the depressed parts of the first toy block and the second toy block, while a state in which the first toy block and the second toy block are linked together is maintained, to allow the first toy block to rotate relative to the second toy block.

7. The assembly toy of claim 6, wherein the projecting parts provided on each of the flat surfaces are equal in number to the depressed parts provided on each of the flat surfaces.

8. The assembly toy of claim 6, wherein each of the toy blocks has a pair of the flat surfaces disposed in parallel with each other.

9. The assembly toy of claim 7, wherein each of the toy blocks has a pair of the flat surfaces disposed in parallel with each other.

10. The assembly toy of claim 8, wherein positions of the projecting parts and the depressed parts provided on one of the pair of the flat surfaces are different in phase from positions of the projecting parts and the depressed parts provided on the other one of the pair of the flat surfaces.

11. The assembly toy of claim 9, wherein positions of the projecting parts and the depressed parts provided on one of the pair of the flat surfaces are different in phase from positions of the projecting parts and the depressed parts provided on the other one of the pair of the flat surfaces.

12. The assembly toy of claim 6, wherein each of the toy blocks has at least two of the flat surfaces disposed in mutually different directions.

13. The assembly toy of claim 7, wherein each of the toy blocks has at least two of the flat surfaces disposed in mutually different directions.
